(19) United States
(12) Patent Application Publication
(10) Pub. No.: US 2005/0225640 A1
(43) Pub. Date: Oct. 13, 2005

(54) Calibration camera device and calibration system

(75) Inventor: Ikuharu Sadano, Hachioji City (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/101,267

(22) Filed: Apr. 7, 2005

(30) Foreign Application Priority Data
Apr. 8, 2004 (JP) 2004-114,388

(51) Int. Cl. H04N 17/02

(52) U.S. Cl. 348/187

(57) ABSTRACT

A calibration camera device for geometrical correction or color correction, including a camera mechanism containing a lens, a near-infrared light cutting filter and an imaging element, an optical filter mechanism with three through eight optical filters which is provided in front of the lens, a filter switching mechanism to select any one from among the optical filters and dispose the selected one optical filter at a photometric point, an external cover having an opening formed in front of the lens and covering the optical filter mechanism, the filter switching mechanism and the camera mechanism, an dustproof transparent member to be attached to the opening of said external cover, and a controller which includes an image storing part to store an image captured by the imaging element and a correction information generating part to generate correction data on the image.

### BACKGROUND OF THE INVENTION

1. Field of the Invention

The present invention relates to a calibration camera device which can be used in geometrical correction in combination with color correction by itself and to a calibration system which is preferably used in image quality control of a table image displaying device and the like to display different images on corresponding divided areas of a screen.

2. Description of the Related Art

Conventionally, an image displaying device has been proposed wherein a plurality of images are projected from the corresponding projectors and synthesized as one large image on one screen. At each projector, however, may occur geometrical distortion, color shading, luminance shading, difference in gamma characteristic, difference in white balance and the like. In this case, the differences in image quality between the projectors become conspicuous, thereby deteriorating the displaying quality of the image displaying device. In this point of view, a calibration system is proposed wherein a calibration camera device is provided in front of the screen, and a test pattern displayed on the screen is captured, and correction data is calculated on the captured image, and the input image is corrected on the correction data and output, thereby conducting geometrical correction, color correction and the like.

As the calibration camera device to be used in the calibration system may be exemplified a calibration camera device as shown in FIG. 7 (see, Patent Publication 1). The calibration camera device is configured so that 16 interference filters 52-1˜52-16 with different colors are attached to 16 openings 51a which are formed at a turret 51 with double-faced tape, and a motor to rotatably support the turret 51 is fixed to a fixing member 54 joined with a camera base 53, and a test pattern projected on a measuring object (e.g., screen) is captured by a CCD camera (not shown) which is provided in the rear of a photometric point P in the lower edge of the turret 51 so as to be fixed to the fixing member 54. Since it is required that one of the interference filters is set to be transparent over a visible light range, in fact, one of the openings 51a is set as it is without the attachment of the interference filter. Since the calibration camera device is developed for study, the calibration camera device is formed as a 16 band camera which captures an image through the 16 (in fact, 15) interference filters.
[Patent Publication] Japanese Patent Application Laid-open No. 2003-134351.

With the calibration camera device disclosed in Patent Publication No. 1, since the 16 (in fact, 15) interference filters are employed to constitute the 16 band camera, the size of the calibration camera device is enlarged and the cost of the calibration camera device is increased due to the use of the expensive interference filters. Also, since a near-infrared light cutting filter is not provided in the CCD camera, a near-infrared light may affect on the calibration camera device which is designed for a given multi-displaying device, depending on the kinds of projectors of the multi-displaying device. In this case, even though the calibration camera device is employed, the image quality of an image projected from the multi-displaying device may be deteriorated.

### SUMMARY OF THE INVENTION

It is a first object of the present invention to provide a not expensive and small calibration camera device with good dustproof wherein in order to realize an image quality as designed, geometrical correction and color correction can be conducted by itself by selecting and using optical filters as desired.

It is a second object of the present invention to provide a calibration system which is preferably employed in the image quality control of a table displaying device by using a not expensive and small calibration camera device with good dustproof wherein geometrical correction and color correction can be conducted by itself.

In order to achieve the first object, the invention of claim 1 relates to a calibration camera device for geometrical correction or color correction, comprising:
a camera mechanism containing a lens, a near-infrared light cutting filter and an imaging element which are arranged on the same optical path,
an optical filter mechanism with three through eight optical filters which is provided in front of the lens on the optical path,
a filter switching mechanism to select any one from among the optical filters and dispose the selected one optical filter at a photometric point on the optical path,
an external cover having an opening formed in front of the lens on the optical path and covering the optical filter mechanism, the filter switching mechanism and the camera mechanism,
a dustproof transparent member to be attached to the opening of the external cover, and
a controller which includes an image storing part to store an image captured by the imaging element and a correction information generating part to generate correction information on the image captured through the selected one optical filter and which controls the camera mechanism and said filter switching mechanism in operation.

The invention of claim 2 relates to a calibration camera device as defined in claim 1, wherein the optical filter mechanism includes the three through eight optical filters and a turret with a plurality of openings to which the optical filters are attached, and the filter switching mechanism includes a motor to rotatably drive the turret around the center axis thereof on an indication from the controller and a sensor to detect a rotational position of the turret.

The invention of claim 3 relates to a calibration camera device as defined in claim 1, wherein the optical filter is a gelatine optical filter.

The invention of claim 4 relates to a calibration camera device as defined in claim 2, wherein the motor is a step motor.

In order to achieve the second object, the invention of claim 5 relates to a calibration system, comprising:
a calibration camera device as defined in claim 1, and
a fixing member to fix said calibration camera device to a given structural body,
wherein geometrical correction and color correction are conducted on a test pattern image which is displayed on a screen of a table displaying device disposed on an optical path and is captured.

The invention of claim 6 relates to a calibration system as defined in claim 5, further comprising a reflective mirror which is provided in front of the calibration camera and deflects the optical path by a given angle.

The invention of claim 7 relates to a calibration system, comprising:
a calibration camera device as defined in claim 2, and
a fixing member to fix said calibration camera device to a given structural body,
wherein geometrical correction and color correction are conducted on a test pattern image which is displayed on a screen of a table displaying device disposed on an optical path and is captured.

The invention of claim 8 relates to a calibration system as defined in claim 7, further comprising a reflective mirror which is provided in front of the calibration camera and deflects the optical path by a given angle.

The invention of claim 9 relates to a calibration system, comprising:
a calibration camera device as defined in claim 3, and
a fixing member to fix said calibration camera device to a given structural body,
wherein geometrical correction and color correction are conducted on a test pattern image which is displayed on a screen of a table displaying device disposed on an optical path and is captured.

The invention of claim 10 relates to a calibration system as defined in claim 9, further comprising a reflective mirror which is provided in front of the calibration camera and deflects the optical path by a given angle.

The invention of claim 11 relates to a calibration system, comprising:
a calibration camera device as defined in claim 4, and
a fixing member to fix said calibration camera device to a given structural body,
wherein geometrical correction and color correction are conducted on a test pattern image which is displayed on a screen of a table displaying device disposed on an optical path and is captured.

The invention of claim 12 relates to a calibration system as defined in claim 11, further comprising a reflective mirror which is provided in front of the calibration camera and deflects the optical path by a given angle.

The invention of claim 13 relates to a calibration system, comprising:
a calibration camera device as defined in claim 1, and
a fixing member to fix the calibration camera device to a given structural body,
wherein geometrical correction and color correction are conducted on a test pattern image which is displayed on a vertical screen of a vertical displaying device disposed on an optical path and is captured.

The invention of claim 14 relates to a calibration system, comprising:
a calibration camera device as defined in claim 2, and
a fixing member to fix the calibration camera device to a given structural body,
wherein geometrical correction and color correction are conducted on a test pattern image which is displayed on a vertical screen of a vertical displaying device disposed on an optical path and is captured.

The invention of claim 15 relates to a calibration system, comprising:
a calibration camera device as defined in claim 3, and
a fixing member to fix the calibration camera device to a given structural body,
wherein geometrical correction and color correction are conducted on a test pattern image which is displayed on a vertical screen of a vertical displaying device disposed on an optical path and is captured.

The invention of claim 16 relates to a calibration system, comprising:
a calibration camera device as defined in claim 4, and
a fixing member to fix the calibration camera device to a given structural body,
wherein geometrical correction and color correction are conducted on a test pattern image which is displayed on a vertical screen of a vertical displaying device disposed on an optical path and is captured.

According to the invention of claim 1, since the calibration camera device is configured so that the optical filter mechanism with three through eight optical filters are provided in front of the camera mechanism containing a capturing lens, a near-infrared light cutting filter and an imaging element which are arranged on the same optical path, and any one optical filter is selected from among the optical filters and disposed at the photometric point on the optical path by the filter switching mechanism, and the optical filter mechanism, the filter switching mechanism and the camera mechanism are covered with the external cover, and the dustproof transparent member is attached to the opening of the external cover which is formed in front of the capturing lens on the optical path, and the image captured by the imaging element is stored in the image storing part of the controller, and the correction information is generated on the image captured through the selected one optical filter by the correction information generating part of the controller, by controlling the camera mechanism and the filter switching mechanism in operation by the controller, the correction information can be obtained at every image captured through the corresponding optical filter, and the geometrical correction and the color correction can be conducted at every correction information for the corresponding image. In this case, since the number of the optical filters is set to three through eight, the number of the optical filters can be selectively set as designed for realizing the intended image quality. Therefore, the not expensive and small calibration camera device with good dustproof can be provided wherein the geometrical correction and the color correction can be conducted by itself.

According to the invention of claim 2, since the optical filter mechanism includes the three through eight optical filters and a turret with a plurality of openings to which the optical filters are attached, and the filter switching mechanism includes a motor to rotatably drive the turret around the center axis thereof on an indication from the controller and a sensor to detect a rotational position of the turret, any one optical filter is selected from among the three through eight optical filters and disposed at the photometric point on the optical path as designed. In this case, since the number of the optical filters to be attached to the turret is set to three through eight, the size and cost of the optical filter mechanism can be remarkably reduced in comparison with the 16 band calibration camera as disclosed in Patent Publication No. 1.

According to the invention of claim 4, since the motor is a step motor, the operation of the filter switching mechanism of any one optical filter being selected from among the three through eight optical filters and disposed at the photometric point on the optical path” can be easily conducted.

According to the inventions of claims 5, 7, 9 and 11, the calibration system is configured so that a calibration camera device as defined in any one of claims 1-4 and a fixing member to fix the calibration camera device to a given structural body are provided, whereby geometrical correction and color correction are conducted on a test pattern image which is displayed on a screen of a table displaying device disposed on an optical path and is captured. Therefore, the calibration system can be constituted as a preferred one in the image quality control of a table displaying device.

According to the inventions of claims 6, 8, 10 and 12, since a reflective mirror is provided in front of the calibration camera device so as to deflect the optical path by a given angle, the image on the screen can be captured by deflecting the optical path by the reflective mirror even though the distance between the screen and the structural body is short.

According to the inventions of claims 13-16, the calibration system is configured so that a calibration camera device as defined in any one of claims 1-4 and a fixing member to fix the calibration camera device to a given structural body are provided, whereby geometrical correction and color correction are conducted on a test pattern image which is displayed on a vertical screen of a vertical displaying device disposed on an optical path and is captured. Therefore, the calibration system can be constituted as a preferred one in the image quality control of the vertical displaying device.

### BRIEF DESCRIPTION OF THE DRAWINGS

In order to bring about a greater understanding of the present invention, a description will be given on the accompanying drawings.

FIG. 1 is a perspective view showing the entire structure of a calibration camera device according to a first embodiment of the present invention,

FIG. 2 is a perspective view of the calibration camera device of the first embodiment, as viewed from the filter mechanism,

FIG. 3 is a cross sectional view showing the camera mechanism to be used for the calibration camera device of the first embodiment,

FIG. 4 is a perspective view showing an external cover covering the optical filter mechanism, the filter switching mechanism the camera mechanism of the calibration camera device of the first embodiment,

FIG. 5 is a perspective view of the entire structure of a calibration system to a first embodiment of the present invention,

FIG. 6 is a perspective view of the entire structure of a calibration system according to a second embodiment of the present invention, and

FIG. 7 is a perspective view showing the entire structure of a conventional calibration camera device.

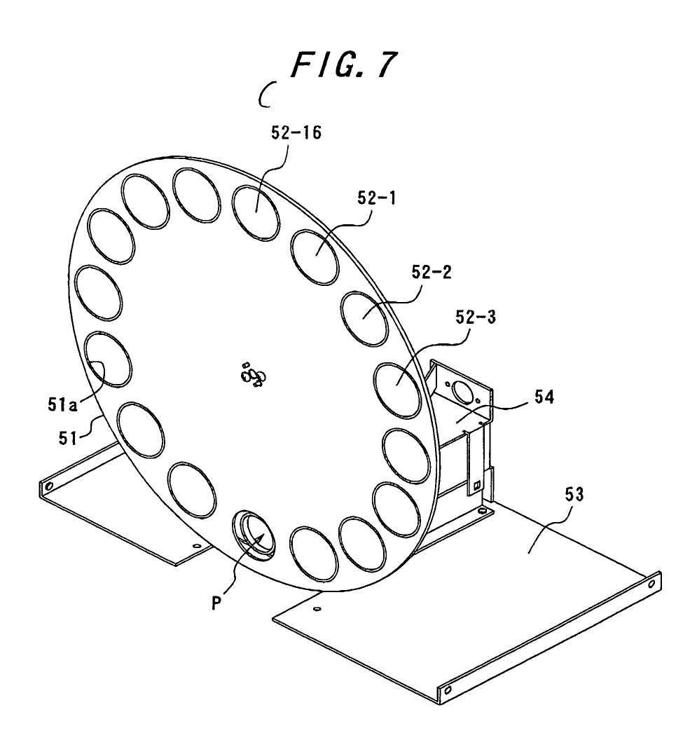

### DETAILED DESCRIPTION OF THE PREFERRED EMBODIMENTS

The present invention will now be described hereinafter with reference to the accompanying drawings.

[Calibration Camera Device]

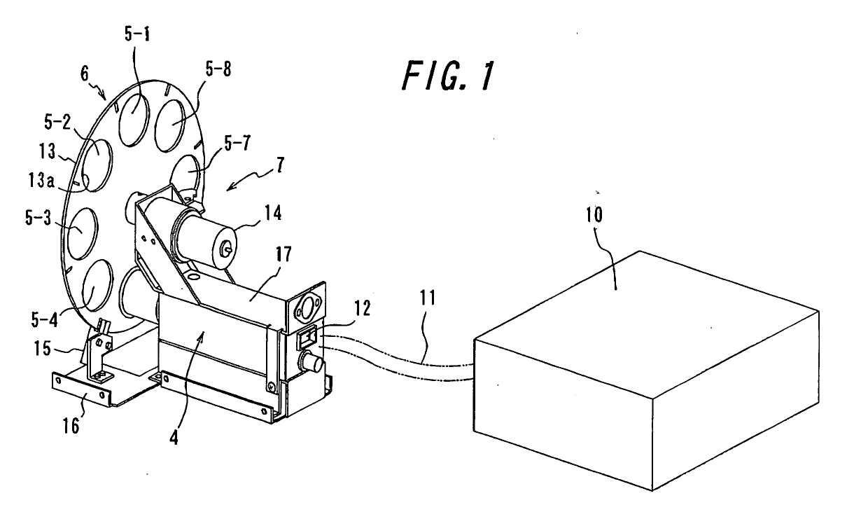

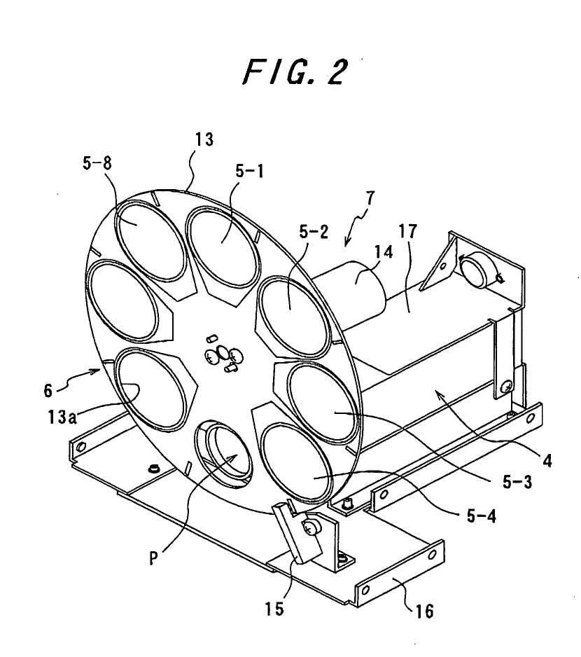

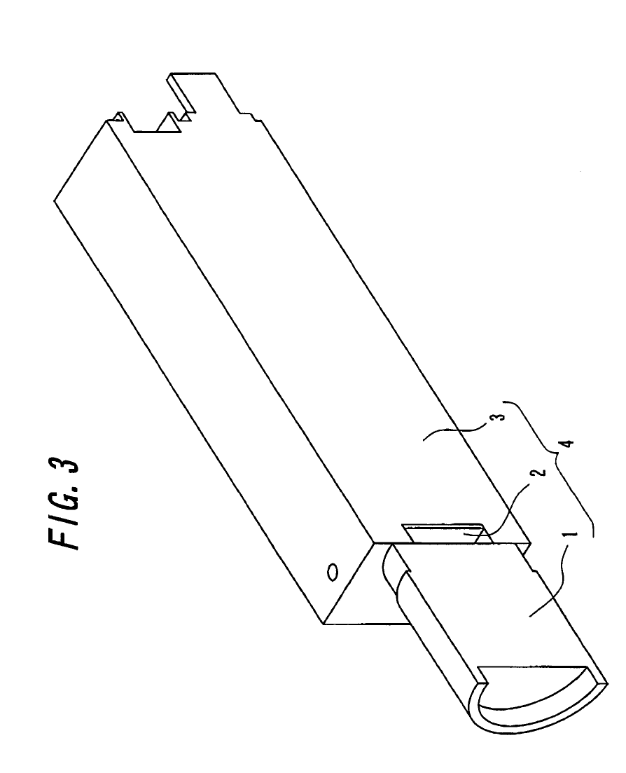

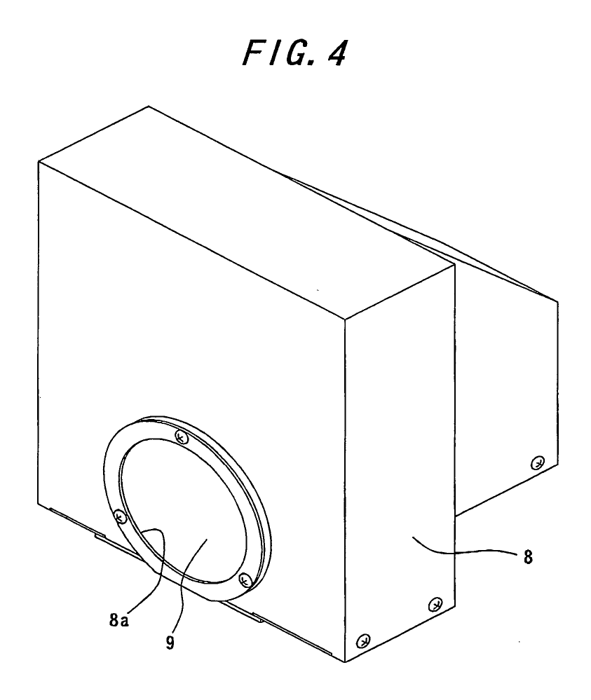

FIG. 1 is a perspective view showing the entire structure of a calibration camera device according to a first embodiment of the present invention. FIG. 2 is a perspective view of the calibration camera device of the first embodiment, as viewed from the filter mechanism. FIG. 3 is a cross sectional view showing the camera mechanism to be used for the calibration camera device of the first embodiment. FIG. 4 is a perspective view showing an external cover covering the optical filter mechanism, the filter switching mechanism and the camera mechanism of the calibration camera device of the first embodiment.

In this embodiment, the calibration camera device is configured so that geometrical correction and color correction can be conducted simultaneously, and as shown in FIG. 1, includes a camera mechanism 4 (refer to FIG. 3) which is composed of an optical lens 1, a near-infrared light cutting filter 2, and an imaging element 3 which are arranged on the same optical path, an optical filter mechanism 6 which is provided in front of the camera mechanism 4 on the optical path and to which three through eight optical filters 5 (in this embodiment, eight optical filters 5-1˜5-8) are attached, a filter switching mechanism 7 which selects one among the optical filters 5 which are attached to the optical filter mechanism 6 and disposes the selected one at the photometric point P on the optical path L (refer to FIG. 2), an external cover (refer to FIG. 4) which covers the optical filter mechanism 6, the filter switching mechanism 7 and the camera mechanism 4 and has an opening 8a formed in front of the lens 1 on the optical path, a plate glass 9 to be attached to the opening 8a of the external cover 8 as a dustproof transparent member, and a controller 10 which includes an image storing part (not shown) to store an image captured by the imaging element 8 and a correction information generating part (not shown) to generate correction data on an image captured through an optical filter selected by the filter switching mechanism 6 and which controls the operation of the camera mechanism 4 and the filter switching mechanism 6. The surface of the external cover 8 is painted in black, and the controller 10 is connected to an IEEE 1394 connector 12 which is provided at the rear end of the camera mechanism 4 via an IEEE1394 cable 11, as shown in FIG. 1. Herein, a USB 2.0 cable may be used instead of the IEEE1394 cable 11 and a USB 2.0 connector may be used instead of the IEEE1394 connector 12.

In this embodiment, the calibration camera device is configured so as to satisfy the desired image quality of a 16 band calibration camera for study as disclosed in Patent Publication No. 1, and modified to be downsized and reduced in cost. In this point of view, the calibration camera device is constituted as an eight band calibration camera device using eight optical filters 5-1˜5-8.

As the lens 1 may be exemplified a lens commercially available. As the imaging element 8 may be exemplified a monochrome CCD camera or a CMOS sensor. In this embodiment, the monochrome CCD camera is used. Instead of the monochrome imaging element, a color imaging element may be employed. As the part may be exemplified a CCD camera installing a near-infrared light cutting filter 2 in advance or a CCD camera not installing the near-infrared light cutting filter. In the latter case, the near-infrared light cutting filter is installed in the calibration camera device in advance.

As the optical filters 5 (optical filters 5-1˜5-8) may be exemplified soft filmy optical filers, respectively. In this embodiment, the optical filters 5 are made of gelatine optical filters as not expensive soft filmy optical filters, respectively. In this case, if each optical filter can not almost exhibit the desired spectral transmittance characteristic when each optical filter is made of one gelatine optical film, each optical filter is made of a plurality of soft filmy optical filters. In use, the plurality of soft filmy optical filters are overlapped with one another so that the desired spectral transmittance characteristic of the corresponding optical filter can be realized. The optical filters are configured so that the optical filters can have respective different colors. In the geometrical correction, one of the optical filters is set to be transparent over a visible light range, so that one of the openings 13a is configured as it is without optical filters. In this point of view, in fact, only seven optical filters are prepared.

The optical filter mechanism 6, as shown in FIGS. 1 and 2, is composed of a motor 14 to rotatably drive a turret 13 around the center axis on the indication from the controller 10 and a sensor 15 to detect the rotational position of the turret 13. The motor 14 rotatably supports the turret 13, and fixed to a fixing member 17 joined to a camera base 16. In this embodiment, the motor is made of a step motor so as to select a desired one from among the optical filters 5-1˜5-8.

The controller 10 is made of a PC or an image processing device for exclusive use. In this embodiment, although the controller 10 and the camera mechanism 4 are connected via the IEEE1394 cable, they may be connected not via a cable by using a radio transmitter and receiver which is provided between the controller 10 and the camera mechanism 4.

Then, the operation in calibration of the calibration camera device will be described hereinafter.

First of all, an image which is captured by the camera mechanism 4 through the optical filter 5-1 is stored in the image storing part on the indication in operation which is transferred to the camera mechanism 4 and the filter switching mechanism 7 from the controller 10. This step is repeated using the optical filters 5-2 through 5-8 subsequently. Then, correction data are automatically generated by the correction information generating part on the images stored in the image storing part. The detail generating mechanism has been already known and e.g., is disclosed in the paragraphs [0047]˜[0067] of the specification of Japanese Patent Application Laid-open No. 2002-72359.

According to the calibration camera device of this embodiment, since the number of the optical filters is set to eight (in fact, seven) so as to realize a sufficient image quality in view of the number of optical filters to be attached to the optical filters 6 in the conversion of study use into mass-production use, the number of the optical filters in this embodiment (the present invention) can be set as half as the number of the optical filters in the 16 (in fact, 15) band calibration camera disclosed in Patent Publication No. 1. In this point of view, since the size of the turret 13 can be reduced, the total size of the calibration camera device can be reduced and the setting space of the calibration camera device can be also reduced. Moreover, in this embodiment, since the optical filters are made of the not expensive gelatine filters instead of expensive interference filters in addition to the reduction in number of the optical filters, the cost of the optical filters can be reduced as one-fourth as the cost of the optical filters of the 16 band calibration camera disclosed in Patent Publication No. 1. In addition, since the measurement number can be reduced as half as the measurement number in the 16 band calibration camera because the number of the optical filters is reduced, the calibration period of time can be also reduced. According to the calibration camera device of this embodiment, since the optical filter mechanism 6, the filter switching mechanism 7 and the camera mechanism 4 are covered with the external cover 8 to constitute a dustproof structure, the age-degradation of the gelatine filters can be prevented and the durability of the gelatins filters can be elongated. As a result, according to this embodiment, the not expensive and small calibration camera device with good dustproof can be provided wherein the geometrical correction and the color correction can be conducted by itself.

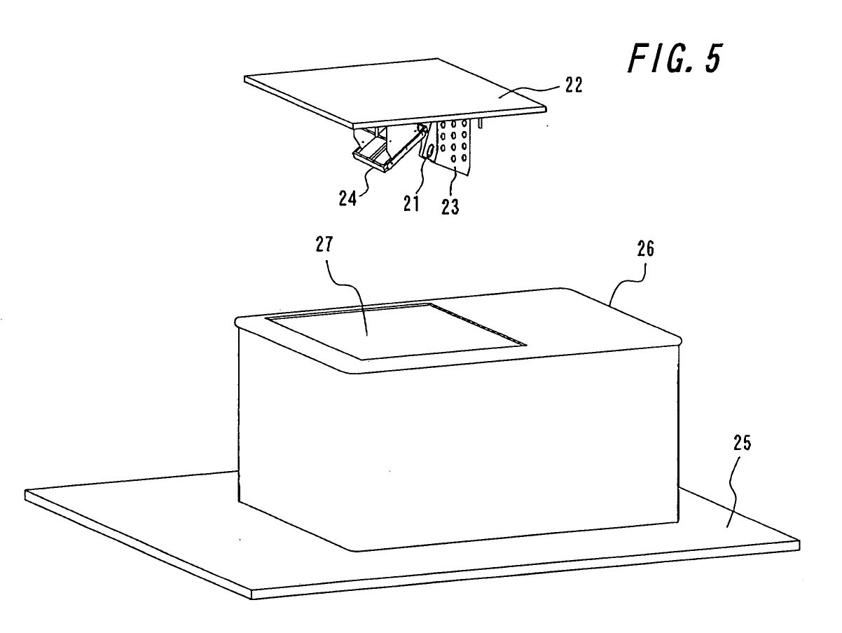

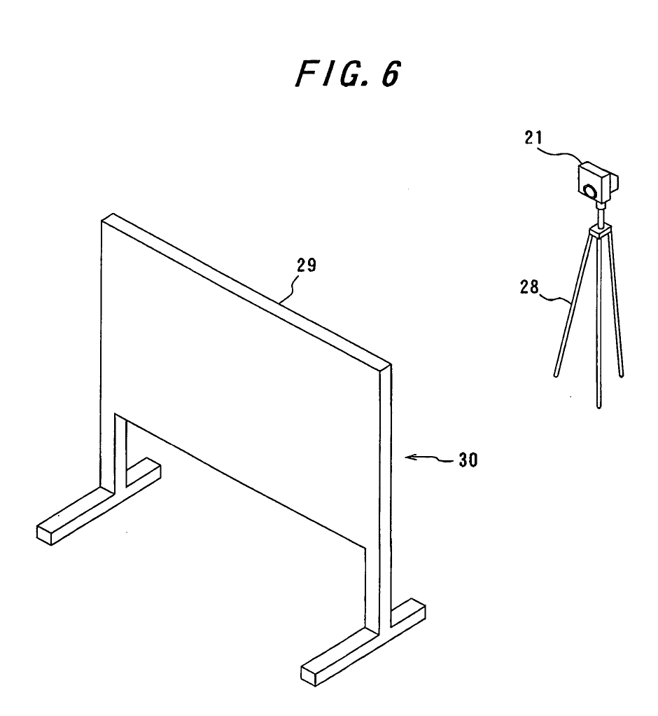

Then, a calibration system according to the present invention will be described hereinafter. FIG. 5 is a perspective view of the entire structure of a calibration system to a first embodiment of the present invention. FIG. 6 is a perspective view of the entire structure of a calibration system according to a second embodiment of the present invention.

[Calibration System]

### First Embodiment

In this embodiment, a calibration camera system is composed of the calibration camera device of the first embodiment, and as shown in FIG. 5, is composed of a calibration camera device 21 (for easy explanation, only a part corresponding to the photometric point P is illustrated), a ceiling camera attaching unit 23 as a fixing member to fix the calibration camera device 21 to a given structural body (in this embodiment, a ceiling 22) and an reflective mirror 24 which is provided in front of the calibration camera device 21 on the optical path and which deflects the optical path by a given angle. The calibration system is configured so that the geometrical correction and the color correction are conducted on a test pattern image which is displayed on a screen 27 of a table displaying device 26 positioned on a floor 25 on the deflected optical path and is captured. In FIG. 5, in the attachment of the calibration camera device 21 on the ceiling 22 positioned directly above the screen 27 of the table displaying device 26, since the distance between the screen 27 and the ceiling 22 is short, the calibration system is configured so that the image on the screen 27 can be captured by deflecting the optical path by the reflective mirror 24. However, if the distance between the screen 27 and the ceiling 22 is long, the reflective mirror 24 may be omitted.

According to the calibration camera system of this embodiment, since the not expensive and small calibration camera device with good dustproof can be provided wherein the geometrical correction and the color correction can be conducted by itself is employed, the calibration system can be constituted as a preferred one in the image quality control of a table displaying device wherein color correction and the like are required due to the use of multi-screen. The color repeatability of the table displaying device can be enhanced by the calibration system.

### Second Embodiment

In this embodiment, a calibration camera system is composed of the calibration camera device of the first embodiment, and as shown in FIG. 6, is composed of the calibration camera device 21, a tripod stand to support the calibration camera device almost horizontally and a vertical displaying device 30 which is provided in front of the calibration camera device 21 on the optical path and has a vertical screen 29. The calibration system is configured so that the geometrical correction and the color correction are conducted on a test pattern image which is displayed on the vertical screen 29 and captured. A projector to photograph an image may be provided in front of or the rear of the vertical screen.

According to the calibration camera system of this embodiment, since the not expensive and small calibration camera device with good dustproof can be provided wherein the geometrical correction and the color correction can be conducted by itself is employed, the calibration system can be constituted as a preferred one in the image quality control of the vertical displaying device. The color repeatability of the vertical displaying device can be enhanced by the calibration system.

Although the present invention was described in detail with reference to the above examples, this invention is not limited to the above disclosure and every kind of variation and modification may be made without departing from the scope of the present invention.

1. A calibration camera device for geometrical correction or color correction, comprising:
a camera mechanism containing a lens, a near-infrared light cutting filter and an imaging element which are arranged on the same optical path,
an optical filter mechanism with three through eight optical filters which is provided in front of said lens on the optical path,
a filter switching mechanism to select any one from among said optical filters and dispose said selected one optical filter at a photometric point on the optical path,
an external cover having an opening formed in front of said lens on the optical path and covering said optical filter mechanism, said filter switching mechanism and said camera mechanism,
a dustproof transparent member to be attached to said opening of said external cover, and
a controller which includes an image storing part to store an image captured by said imaging element and a correction information generating part to generate correction information on said image captured through said selected one optical filter and which controls said camera mechanism and said filter switching mechanism in operation.

2. The calibration camera device as defined in claim 1, wherein said optical filter mechanism includes said three through eight optical filters and a turret with a plurality of openings to which said optical filters are attached, and said filter switching mechanism includes a motor to rotatably drive said turret around the center axis thereof on an indication from said controller and a sensor to detect a rotational position of said turret.

3. The calibration camera device as defined in claim 1, wherein said optical filter is a gelatine optical filter.

4. The calibration camera device as defined in claim 2, wherein said motor is a step motor.

5. A calibration system, comprising:
a calibration camera device as defined in claim 1, and
a fixing member to fix said calibration camera device to a given structural body,
wherein geometrical correction and color correction are conducted on a test pattern image which is displayed on a screen of a table displaying device disposed on an optical path and is captured.

6. The calibration system as defined in claim 5, further comprising a reflective mirror which is provided in front of said calibration camera and deflects said optical path by a given angle.

7. A calibration system, comprising:
a calibration camera device as defined in claim 2, and
a fixing member to fix said calibration camera device to a given structural body,
wherein geometrical correction and color correction are conducted on a test pattern image which is displayed on a screen of a table displaying device disposed on an optical path and is captured.

8. The calibration system as defined in claim 7, further comprising a reflective mirror which is provided in front of said calibration camera and deflects said optical path by a given angle.

9. A calibration system, comprising:
a calibration camera device as defined in claim 3, and
a fixing member to fix said calibration camera device to a given structural body,
wherein geometrical correction and color correction are conducted on a test pattern image which is displayed on a screen of a table displaying device disposed on an optical path and is captured.

10. The calibration system as defined in claim 9, further comprising a reflective mirror which is provided in front of said calibration camera and deflects said optical path by a given angle.

11. A calibration system, comprising:
a calibration camera device as defined in claim 4, and
a fixing member to fix said calibration camera device to a given structural body,
wherein geometrical correction and color correction are conducted on a test pattern image which is displayed on a screen of a table displaying device disposed on an optical path and is captured.

12. The calibration system as defined in claim 11, further comprising a reflective mirror which is provided in front of said calibration camera and deflects said optical path by a given angle.

13. A calibration system, comprising:
a calibration camera device as defined in claim 1, and
a fixing member to fix said calibration camera device to a given structural body,
wherein geometrical correction and color correction are conducted on a test pattern image which is displayed on a vertical screen of a vertical displaying device disposed on an optical path and is captured.

14. A calibration system, comprising:
a calibration camera device as defined in claim 2, and
a fixing member to fix said calibration camera device to a given structural body,
wherein geometrical correction and color correction are conducted on a test pattern image which is displayed on a vertical screen of a vertical displaying device disposed on an optical path and is captured.

15. A calibration system, comprising:
a calibration camera device as defined in claim 3, and
a fixing member to fix said calibration camera device to a given structural body,
wherein geometrical correction and color correction are conducted on a test pattern image which is displayed on a vertical screen of a vertical displaying device disposed on an optical path and is captured.

16. A calibration system, comprising:
a calibration camera device as defined in claim 1, and
a fixing member to fix said calibration camera device to a given structural body,
wherein geometrical correction and color correction are conducted on a test pattern image which is displayed on a vertical screen of a vertical displaying device disposed on an optical path and is captured.
